(19) United States
(12) Patent Application Publication
(10) Pub. No.: US 2010/0199323 A1
(43) Pub. Date: Aug. 5, 2010

(54) System for Dynamically Turning On or Off Log On Methods Used for Access to PC or Network Based Systems

(76) Inventors: Greg Salyards, Austin, TX (US); Shaun Cuttill, Austin, TX (US)

Correspondence Address: Greg Salyards, Suite 402, 930 South Bell Boulevard, Cedar Park, TX, 78613, US

(21) Appl. No.: 12/365,785

(22) Filed: Feb. 4, 2009

(51) Int. Cl. G06F 21/00

(52) U.S. Cl. 726/1; 726/2

(57) ABSTRACT

A method or system for dynamically changing the log on environment to a PC or networked based system that allows IT administrators, security personnel or system owners to decide to enable or disable log on methods used for access.

### BACKGROUND OF INVENTION

1. Technical Field

This invention relates to systems, methods, and apparatus that provide for the administration and management of rules or regulations governing the protection of information, services and other data processing resources involving coordination of more than one security mechanisms among a plurality of entities, resources, or processes. The present invention relates specifically to a security application that is capable of managing multiple methods for accessing PCs or network based systems, such as standard user name/password, contact smart card, contactless smart card, biometrics, knowledge based authentication, and so on.

2. Related Technology

“Factor” authentication provides a secure method to prevent unauthorized access to personal, corporate, and government digital information. Two-factor, three-factor and four-factor authentication employ tools such as contact based smart cards, biometric devices, Knowledge-Based Authentication, identity validation services and One-Time Password tokens. “Factors” of authentication can be categorized into physical non-human devices that are “something you have”, human biometrics that are “something you are”, human memory that is “something you know” and personal validation of public records or third-party verification services and the alike that are “something somebody else knows about you”.

Initially user name and password served as a valid means for protecting digital information; however, due to the growth of computer processing power, social networking, personnel complacency with security policy and other threats, organizations were forced to strengthen standard user names and password to such an extent that they have now become unusable, expensive to maintain, and in many cases the desired effect of increased security was not achieved.

As an alternative to user names and passwords, organizations have started to adopt stronger forms of “factor” authentication. Historically organizations and system owners only provided one or in some cases two methods of authenticating to PCs or networked based systems. These methods traditionally were user name/password and some other method, whereby user name/password was constant, such as user name/password OR contact smart card OR user name/password OR fingerprint biometrics. In some cases organizations and system owners have scrambled or obscured the users' password so that the user could only log on with the alternative means, such as a contact smart card or fingerprint biometric. In rare cases security vendors have written special log on environments which replace the default user name and password log on environment, thereby removing the user's ability to log on with user name and password.

These historical processes were a one size fits all approach to user access. The applications were either installed and turned on or uninstalled and not present on the system. There was no in-between or flexibility for the system owner to control the log on environment dynamically or based upon the organization's or system owner's requirements.

### SUMMARY OF INVENTION

A security system for determining whether a person (hereinafter “user”) is authorized to have access to a person, place or technology. Evidence of this authority may be in the form of an issued identification device. The device, by itself or in combination with other security tools such as passwords and PINs, authenticates the identity and authorization of the user. The levels of security and choice of authentication methods can be changed without reinstalling the security system.

### SUMMARY OF DRAWINGS

The features of the invention believed to be novel and the elements characteristic of the invention are set forth with particularity in the appended claims. The figures are for illustration purposes only and are not drawn to scale. The invention itself, however, both as to organization and method of operation, may best be understood by reference to the detailed description which follows taken in conjunction with the accompanying drawings in which:

FIG. 1 illustrates the administrator's portal with the selection of a knowledge based authentication method. This one-factor authentication method is categorized as “something the user knows”.

FIG. 2 illustrates the user's screen with the selection of a knowledge based authentication method. This one-factor authentication method is categorized as “something the user knows”.

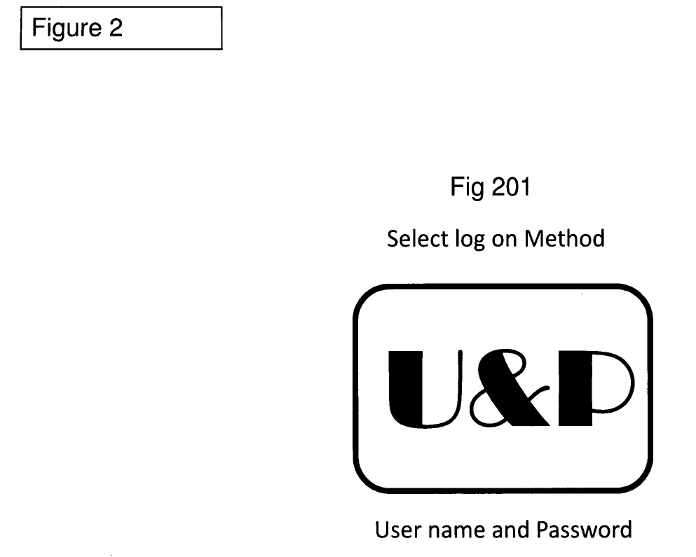

FIG. 3 illustrates the administrator's portal with the selection of a contact based smart card and a biometric. This two-factor authentication method is categorized as “something the user has” and “something the user is”.

FIG. 4 illustrates the user's screen with the selection of a contact based smart card and a biometric. This two-factor authentication method is categorized as “something the user has” and “something the user is”.

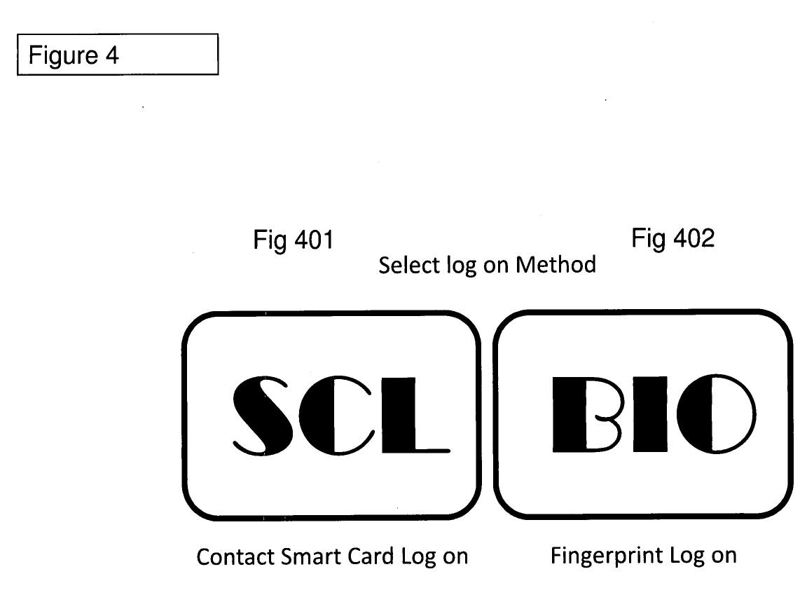

FIG. 5 illustrates the administrator's portal with the selection of a knowledge based authentication, a contact based smart card, and a biometric. This three-factor authentication method is categorized as “something the user knows”, “something the user has”, and “something the user is”.

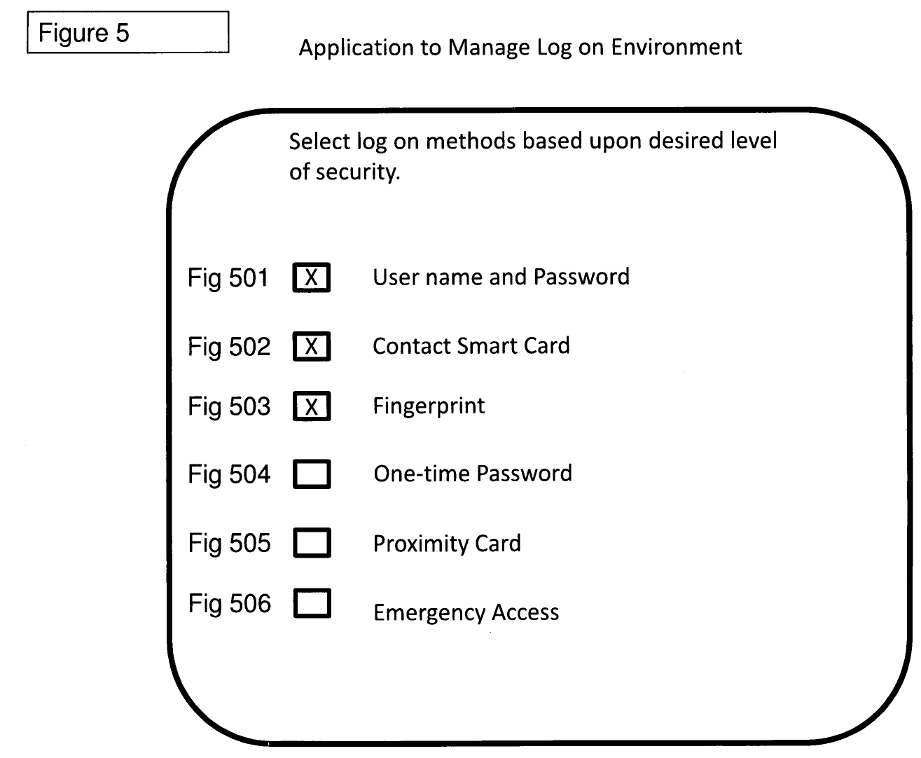

FIG. 6 illustrates the user's screen with the selection of a knowledge based authentication, a contact based smart card, and a biometric. This three-factor authentication method is categorized as “something the user knows”, “something the user has”, and “something the user is”.

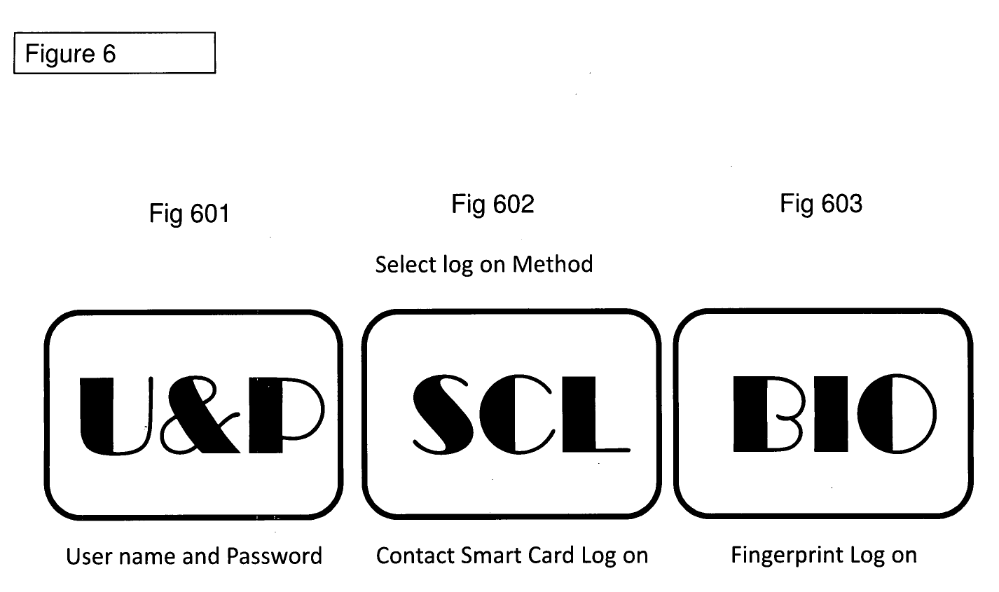

FIG. 7 illustrates the administrator's portal with the selection of a knowledge based authentication, a contact based smart card, a biometric, a third party verification service, and a contactless smart card. This four-factor authentication method is categorized as “something the user knows”, “something the user has” (contact based and contactless smart cards), “something the user is”, and “something somebody else knows about the user”. Emergency Access does not qualify as an authentication method, but it does allow the user to take a singular action such as the self-service reset of a password or the unblocking of a blocked smart card.

FIG. 8 illustrates the user's screen with the selection of a knowledge based authentication, a contact based smart card, a biometric, a third party verification service, and a contactless smart card. This four-factor authentication method is categorized as “something the user knows”, “something the user has” (contact based and contactless smart cards), “something the user is”, and “something somebody else knows about the user”. Emergency Access does not qualify as an authentication method, but it does allow the user to take a singular action such as the self-service reset of a password or the unblocking of a blocked smart card.

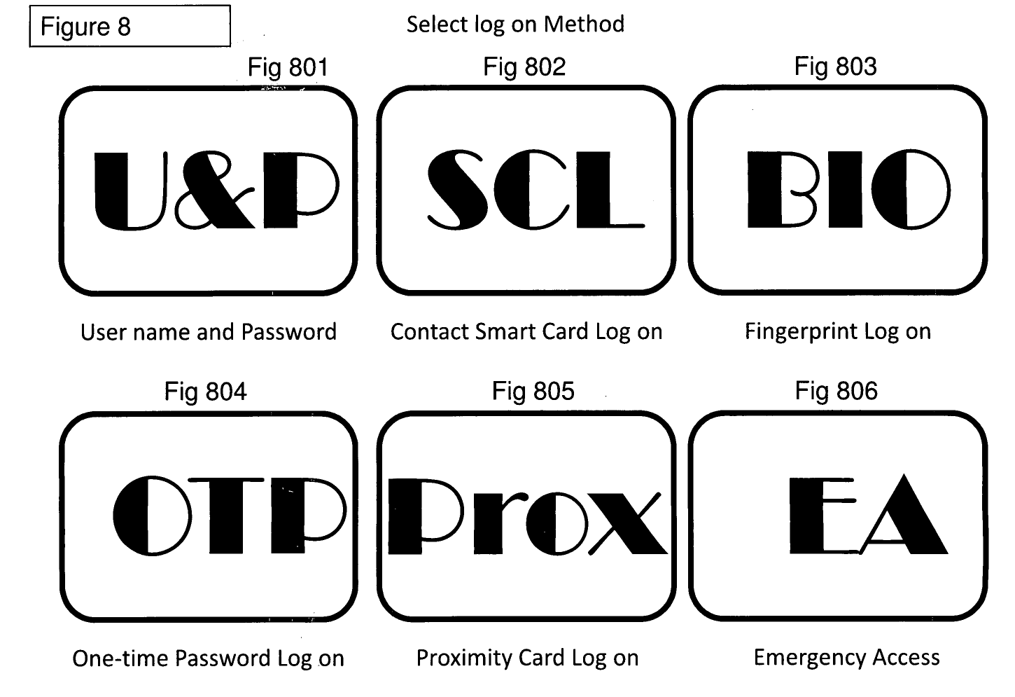

### DETAILED DESCRIPTION OF INVENTION

A system for dynamically turning on and off log oil methods is a security system for determining whether a user is authorized to have access to a person, place or technology.

The invention enables organizations or system owners to install a security application that is capable of managing multiple methods for accessing PCs or network based systems, such as standard user name/password, contact smart card, contactless smart card, biometrics, knowledge based authentication and so on.

Once installed the application will contain a system setting that enables organizations or system owners to select which log on methods are available to users on the specific machine being accessed. The application will not have to be uninstalled or modified to dynamically turn on and off the log on methods. Previous applications were either installed and turned on or uninstalled and not present on the system. There was no in-between or flexibility for the system owner to control the log on environment dynamically or based upon the organization's or system owner's requirements.

Once selected or de-selected the log on environment will dynamically change. A user desiring access to the given PC or network based system may select which authentication method they would like to authenticate with OR may be restricted from authenticating with undesired authentication methods.

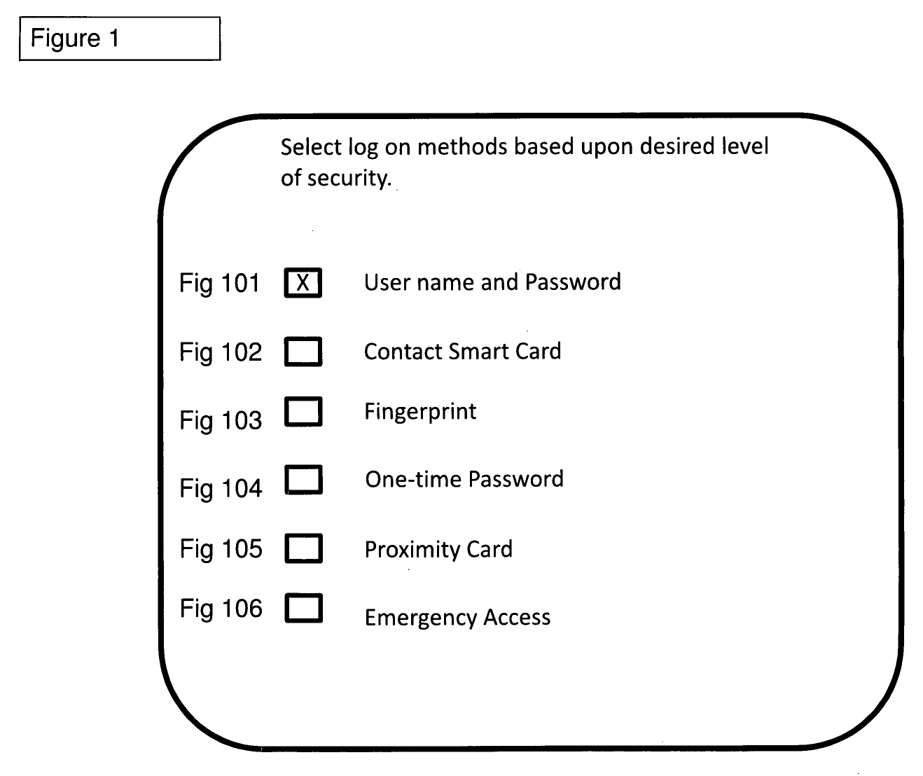

Referring to FIG. 1, the application's selection of authentication method 101 is a choice to rely solely on knowledge based authentication. Authentication method 101, user name and password, is a low security option. The development of computer processing power, social networking, and personnel complacency with security policy have made user name and password authentication methods increasingly less secure.

User name and password is not a default setting. As a low security authentication method, administrators can choose to eliminate it from the user's interface system.

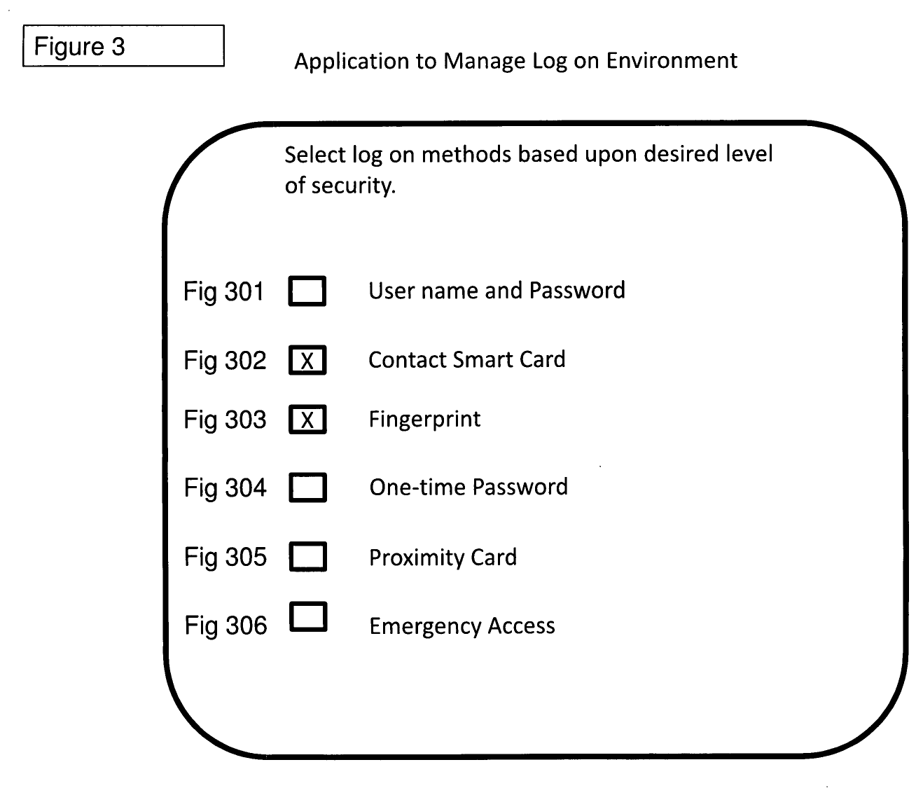

Referring to FIG. 3, authentication method 302, contact smart card, is a physical, non-human device. A contact smart card must be presented to a smart card reader with a direct connection to a conductive contact plate on the surface of the card. Transmission of commands, data, and card status takes place over these physical contact points.

Referring to FIG. 3, authentication method 303, fingerprint, is a human biometric. To use this authentication method, the user must present his/her own fingerprint to the application for verification.

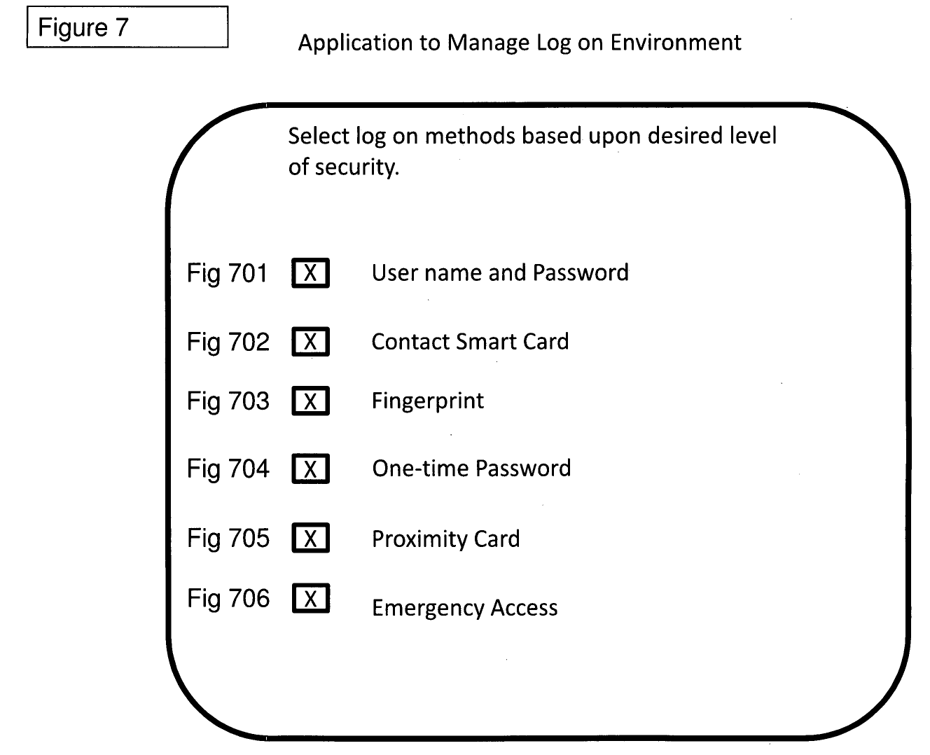

Referring to FIG. 7, authentication method 704, one-time password, is an authentication method that is modified for each log on event. One-time passwords are less likely to be compromised than static passwords. One-time passwords can be generated in three different ways: by using a mathematical algorithm to generate a new password based on the previous, by time-synchronization with the authentication server and the client providing the password, by using a mathematical algorithm to generate a password based on a challenge and a counter.

Referring to FIG. 7, authentication method 705, proximity smart card, is a physical, non-human device. A proximity card requires only that it be close to the reader. Both the reader and the card have antennae, and the two communicate using radio frequencies (RF) over this contactless link. Most contactless cards also derive power for the internal chip from this electromagnetic signal. The range is typically one-half to three inches for non-battery-powered cards, ideal for applications such as building entry and payment that require a very fast card interface.

Referring to FIG. 7, authentication method 706, emergency access, is included in all of the applications' settings. In the event of emergency access log on the user will be presented with a screen in which the user provides their user name and log-on domain. Once provided, the application will retrieve the questions selected by the user during enrollment. The user may be presented with an entire list of these questions or a subset thereof. If no action is taken by the administrator, the application will present the user with a list of 27 questions from which the user must select ten to answer. The user must provide correct answers to each of the questions. In the event the user fails to provide the correct answers to the questions, the application will generate a new list of previously selected questions. This process will continue until the user provides the correct answers to all the provided questions or the user fails to provide the correct answers.

What is claimed is:

1. A method for user authentication, the method comprising a security application that enables organizations or system owners to manage multiple mechanisms for accessing PCs or network based systems.

2. The method of claim 1, wherein the security application is for determining whether a person is authorized to have access to a person, place or technology.

3. The method of claim 1, wherein the mechanisms include standard name and password, contact smart card, contactless smart card, biometrics, knowledge based authentication, and so on. The types of authentication mechanisms are only limited by innovation.

4. The method of claim 2, wherein the security application will contain a system setting that enables organizations or system owners to select which log on methods are available to users on the specific machine being accessed.

5. The method of claim 2, wherein the security application will allow log on methods to be dynamically turned on or off without requiring that the application be uninstalled or modified programmatically.

6. The method of claim 5, wherein the ability to dynamically turn on or off log on methods should be restricted to system administrators of the system being managed.

7. The method of claim 5, wherein the system administrators can effect change in the log on environment by setting policy on the local machine within the application that controls that log on environment OR remotely through a policy server that controls and enforces policy on multiple PCs or network based systems.

8. A security application that allows system administrators, security personnel or system owners to elect which authentication mechanisms are most appropriate for a given system based upon the potential risk to the organization or system owner in the event of an attack on the system.
